(19) United States
(12) Patent Application Publication
(10) Pub. No.: US 2002/0080164 A1
(43) Pub. Date: Jun. 27, 2002

(54) Display of advertising on computer monitor

(76) Inventor: Richard Tucker, Beverly Hills, CA (US)

Correspondence Address: COLIN P ABRAHAMS, 5850 CANOGA AVENUE, SUITE 400, WOODLAND HILLS, CA, 91367

(21) Appl. No.: 09/862,692

(22) Filed: May 22, 2001

Related U.S. Application Data
(60) Provisional application No. 60/206,118, filed on May 22, 2000.

(51) Int. Cl. G09G 5/00

(52) U.S. Cl. 345/738

(57) ABSTRACT

A method of providing advertising material to a computer for display on a monitor of the computer comprises connecting the computer to the Internet using a modem or other communication device or system. The computer is then linked with a website on the internet having a selection of advertising material, and at least selected portions of the advertising material are transferred to the computer for storage thereon. The advertising material is displayed on the monitor of the computer at a predetermined time for observation by a user of the computer.

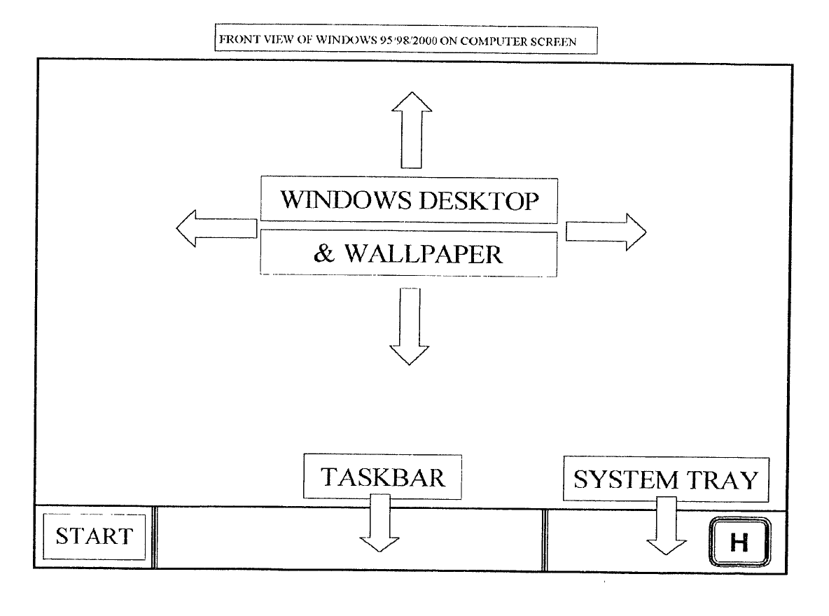

This application claims the benefit of U.S. Provisional application No. 60/206,118 filed May 22, 2000.

The invention relates to a system and method for the display of advertising on computer monitors, including software. The invention also relates to monitoring and analyzing information relating to such advertising, including sending at least some of the information to remote computer(s) for such monitoring. The invention has many applications and uses, and may include the various steps and procedures, in any one or more combinations, described below.

The description below may be viewed in conjunction with the enclosed FIGURE, which shows in diagrammatic outline an overall map of a typical computer desktop display.

The system of the invention is initiated when the user installs advertising display software. The user is then asked to reboot computer. When the computer reboots, the advertising display software is now loaded.

The advertising display software is not activated until the mouse is moved. Once the mouse is moved, the advertising display software recognizes mouse movement, and then begins to play the first full screen commercial. The commercial can be set to play for any length of time, but no more than 15 seconds would be preferred.

The computer user may have the option to cancel commercial play by pressing the escape key on the computer keyboard, or by right clicking on the mouse, and selecting from the menu that appears, to stop, pause, or replay the commercial. If the user opts to cancel the commercial play, then the commercial ceases to play immediately, and returns the user to his regular desktop screen.

Once the commercial has finished playing, the computer user will see their “Desktop” as usual (“Desktop” is a “Windows” terminology meaning the main computer screen). When the computer user attempts to log-on to the Internet or the World Wide Web (www.), the advertising display software will automatically recognize that the computers user's modem is attempting to connect to an Internet Service Provider's (I.S.P.) server. Once the advertising display software recognizes this action, it will then begin to play a full screen commercial.

There is generally a minimum of a forty to fifty second connection time to the I.S.P. where the computer sits idle, until the modem connection is made to the I.S.P.'s server, or in general terms, “Logs On.” This idle connection time is now utilized by the advertising display software, and now begins to play commercials. Because of this forty to fifty second connection time to log on, there is now enough time to play a minimum of three, back to back, ten-second commercials. While the commercials are playing the computer user will also see a small information box which is placed at the bottom of the screen which will relay all the connecting information from their I.S.P.'s software which allows them to see their connecting status, e.g. Dialing Phone Number, Checking Password, Connecting at a speed of 48,000 bps, etc.

After the last commercial has finished playing, there will appear a static screen, which will ask the user to make one of two decisions, “No Thank You” or “Tell Me More.” These decisions can vary in any number of ways according to the preferences and requirements of the advertiser. As an example, a McDonald's™ commercial may play as described in paragraph 14 above, and then at the end of the commercial, the static McDonald's″ page may say on the left, “Click here to continue” and on the right it may say “Click here to print out your “Free Big Mac™” coupon.”

If the computer user wishes to click on “Continue” (the left button option), the static screen will immediately disappear, and the computer user will see his I.S.P.'s home page as usual. However if the computer user opts to click on the right button option, the computer user will initiate that task associated with the button, e.g.: “Print Coupon,” or “Order Product Now,” etc. Once the computer user opts to click the right button and initiates that task, then the computer user now has full control of all additional operations. If, for example, the computer user clicked the right button, and the button asked “Click here to purchase now!”, then usually the user would be re-directed to that advertiser web site, where the computer user can then purchase that particular product, or any other products listed.

At this time, the advertiser has now directed that particular computer user to its web-site, and this user is now that advertiser's responsibility.

Once the computer user has made his decision, from the static page, the static page disappears and the computer user continues according to his selection. At this point, in one aspect or embodiment of the invention, the advertising display software now begins to work in the background of the computer. That is to say, the software will begin its next task, without the computer user ever knowing that it is performing its next task, or with the user's knowledge and understanding when he acquires and instals the system of the invention.

The advertising display software will now be in the background, and automatically log on to “www.advertising display.com”. This may be a website set up as a service to monitor the advertising display software. Once logged on to this site, the software will be told to redirect to the advertiser's server, where the advertiser will store its new commercial, static page, and other information as may be appropriate.

Once the computer user is directed to the advertiser's server, then the advertiser's new commercial (if any) is uploaded to the computer user's hard drive. Once the new commercial or data is uploaded, the next time the commercial plays, it will play either the most recent upload, or at least a different one from that previously played. This provides variety and depth to advertiser's capability. After the computer user has downloaded the advertisement, automatically in the background, then the advertising display software becomes dormant, until the next commercial is scheduled to play, based on the user's use of his computer.

One reason why the software is directed to the Internet website “www.advertising display.com” first is to simply acquire statistics from the computer users. Whenever the computer user logs on the World Wide Web, and the advertising display software is loaded in his computer, then automatically administrators and/or managers of the website “www.advertising display.com” will begin to collect an enormous amount of important data, which will be extremely helpful for both these administrators as well as the advertiser. As an example, it is now possible to establish: how many computer users have downloaded the software; the time or times the computer user logs-on to the web; which products the user is attracted to, as well as a wealth of additional information. In addition to the commercials that play, the software may also contain, in various forms and embodiments, a unique method of presenting the advertiser's logo in a variety of ways on the computer users desktop. When the software is first loaded onto the computer user's computer, a special icon will appear in the “System Tray”, which may often be located at the bottom right hand side of the “Windows” taskbar. (This generally understood to be the bar or information strip which runs across the bottom of the screen containing small icons and the start button). This “System Tray” icon may be placed in the bar in the form of an advertising display logo. When the computer user clicks on this icon, a menu will appear asking the user what task to perform. These tasks may be in the form of set out in one of the following paragraphs.

CHANGE SKIN: Once the computer user places his mouse over this task, an additional menu may automatically appear. This menu will list all the sponsors' names that currently have commercials downloaded onto that particular computer. If the computer user clicks on one of the sponsor's names, then the computer user is commanding the computer to change the computer's skin. What this means is that the computer screen will change it's appearance in a variety of ways, according to the computer user's “SKIN” choice.

The changes preferably take effect immediately in a variety of ways, so of which are described as follows: The computer wallpaper (which is the background image on the computer screen) will now change to an image selected by that advertiser. This could be a large image of the advertiser's logo, or a snap shot image from their commercial. Also on top of the wallpaper, there may be an image of choice, e.g. Coca Cola™ could use the image of a Coke™ can, which may move and spin randomly across the screen, and eventually settle, only then to pop open to hear the trademarked swoosh noise of Coca Cola>. To prevent or discourage the computer user from changing this wallpaper, there may be incentives to keep the wallpaper on the computer user's screen. For example, the Coke™ can would randomly spin and jump, but would eventually come to a halt at a randomly chosen time. The computer user would hear the trademarked swoosh sound of Coca Cola™, and as the front of the Coke™ can opens, a message could be displayed, as follows: “Click Here To Print Your Coupon For Your Free Six Pack of Coca Cola™ now!” The computer user would then print out the coupon on his printer, which in turn could be taken to any local supermarket to be redeemed. This message can also be easily updated and changed by the advertiser, via an Internet connection where new or additional messages can be imported by a background download operation, for later display on the Coke™ can. This in turn would keep the computer user from changing the wallpaper and keep them randomly affixed to their computer screen waiting to benefit from the next coupon or offer from the advertiser.

The computer's screen saver could change to that advertiser's screen saver, which could be a logo floating across the screen, or snap shot images, from the advertiser's commercial that may change every fifteen seconds.

The computer user's mouse (or pointer) image may also change to that advertiser's Three-D logo image, which is still fully functional.

When the computer user clicks on any icon on the main desktop, in order to open that program the computer user has to click twice on the icon. When the icon is clicked the first time, the icon turns a darker shade, and this tells the computer user that he has made a selection for that particular program. At this point, the advertisers logo will appear across the darkened icon. When this icon is clicked a second time, then the program opens and begins to run as usual. There is usually a split second interval between the first and second click from the user's mouse (depending on the click speed), at which point the advertiser's logo would appear across the program icon briefly.

The computer user's desktop may now display a small, almost transparent logo for that advertiser in the lower right hand side, above the taskbar, which remains static. If the logo is double-clicked by the computer user, the user's computer will automatically attempt to log-on to the web in an attempt to send that computer user to the advertiser's web site. The page that the user is directed to on the site may be formatted only for, as an example, special offers, but that would be entirely up to the advertiser. If the computer user is already logged-on to the web, then if that logo is double clicked, then the computer user is automatically and immediately sent to that advertiser's site.

In addition, the advertising display system and software of the invention can always be updated to do a variety of new or improved tasks, simply because when the computer user logs on to the web, the advertising display system and software of the invention is programmed to go to the advertising display website (www.advertising display.com) via a background operation, which may be either known or unknown to the computer user, and retrieve any new updates for the software. This way the advertising display software and system will always be kept current and up to date.

As a secondary option, or a further embodiment, to the flow sequence above, the software may also be programmed to be able to recognize an Internet connection. For example, once the computer user actually logs on to the web, and has established a connection to his I.S.P.'s home page, the software will automatically recognize this action. At this time, the software will only be activated once the computer user moves his mouse. Once activated by the mouse movement, a commercial will then begin to play for any length of time (15 seconds preferred), which, when finished, will again display the static page for that advertiser, asking the computer user to make a selection, or decision. Once the computer user makes that selection or decision, either the advertiser has now directed that particular computer user to its web-site, and this user is now the advertiser's responsibility, or the user elects to “Continue” and immediately returns to his I.S.P.'s home page.

For security reasons, each time a commercial is played on the user's computer, the file which determines and processes for the playback is automatically erased, and re-written with another file, therefore changing the code, so the user can never hack into the file to disrupt the playback.

1. A method of providing advertising material to a computer for display on a monitor of the computer, the method comprising:
connecting the computer to the Internet using a modem or other communication device or system,
linking the computer with a website on the internet having a selection of advertising material,
transferring at least selected portions of the advertising material to the computer for storage thereon,
wherein the advertising material is displayed on the monitor of the computer at a predetermined time for observation by a user of the computer.
